(19) United States
(12) Patent Application Publication
(10) Pub. No.: US 2019/0155662 A1
(43) Pub. Date: May 23, 2019

(54) INFORMATION PROCESSING SYSTEM AND DATA PROCESSING METHOD

(71) Applicant: FUJITSU LIMITED, Kawasaki-shi (JP)

(72) Inventor: Mayuka Kuno, Kobe (JP)

(73) Assignee: FUJITSU LIMITED, Kawasaki-shi (JP)

(21) Appl. No.: 16/174,150

(22) Filed: Oct. 29, 2018

(30) Foreign Application Priority Data
Nov. 22, 2017 (JP) 2017-225158

(51) Int. Cl. G06F 9/50; H04L 29/08; G06F 9/52

(52) U.S. Cl. CPC G06F 9/5083; G06F 9/52; G06F 9/505; H04L 67/10

(57) ABSTRACT

An information processing system includes an input device configured to sequentially transmit a plurality of first processing data pieces to each of a plurality of data processing devices, a data processing device of the plurality of data processing devices, coupled to the input device and configured to sequentially execute data processings on a plurality of first processing data pieces to generate a plurality of first processed data pieces, and an output device coupled to each of the plurality of data processing devices and configured to sequentially transmit a plurality of first data request signals to a first data processing device selected among the plurality of data processing devices, wherein the first data processing device sequentially transmits the plurality of first processed data pieces to the output device in response to the plurality of first data request signals from the output device, respectively.

### CROSS-REFERENCE TO RELATED APPLICATION

This application is based upon and claims the benefit of priority of the prior Japanese Patent Application No. 2017-225158, filed on Nov. 22, 2017, the entire contents of which are incorporated herein by reference.

### FIELD

The embodiments discussed herein are related to an information processing system and a data processing method.

### BACKGROUND

A data processing server that processes stream data transmitted from, for example, a sensor device is required to continuously perform a data processing without causing a data deficiency. For this demand, there is known a method of multiplexing a plurality of data processing servers, in which when a portion of the data processing servers becomes unable to continuously perform a data processing due to, for example, a failure, the data processing is performed by another data processing server as a replacement so that the data deficiency is prevented. In this method, when another data processing server is caused to activate at a time point when a failure occurs in a data processing server that executes a data processing, the data processing may be interrupted until the activation of the another data processing device is completed. Thus, there may be suggested a method of executing data processings by a plurality of data processing servers in parallel in a state where the plurality of data processing servers are always placed in an operating mode. In this case, the sensor data transmitted from a sensor device is firstly input to an input server, and the input server transmits the sensor data to each of the plurality of multiplexed data processing servers. Each of the data processing servers performs a predetermined data processing on the sensor data, and transmits processed data to an output server. The output server selects and outputs one of the processed data pieces transmitted from each of the plurality of data processing servers. In this manner, when the plurality of data processing servers execute data processings in parallel, the output server may continuously output processed data even in a case where a failure has occurred in one data processing server.

Related techniques are disclosed in, for example, Japanese National Publication of International Patent Application No. 2016-526719, Japanese Laid-open Patent Publication No. 2011-192013, and International Publication Pamphlet No. WO 2016-067335.

### SUMMARY

According to an aspect of the embodiments, an information processing system includes an input device configured to include a first memory and a first processor coupled to the first memory, the first processor being configured to sequentially transmit a plurality of first processing data pieces to each of a plurality of data processing devices, a data processing device of the plurality of data processing devices, coupled to the input device and configured to include a second memory and a second processor coupled to the second memory, the second processor being configured to sequentially execute data processings on a plurality of first processing data pieces to generate a plurality of first processed data pieces, and an output device coupled to each of the plurality of data processing devices and configured to include a third memory and a third processor coupled to the third memory, the third processor being configured to sequentially transmit a plurality of first data request signals to a first data processing device selected among the plurality of data processing devices, wherein the second processor of the first data processing device is configured to sequentially transmit the plurality of first processed data pieces to the output device in response to the plurality of first data request signals from the output device, respectively.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration view of an information processing system including a plurality of multiplexed data processing devices;

FIG. 2 is a view illustrating a state where an input device receives sensor data from sensor devices, and transmits processing data to data processing devices;

FIG. 3 is a view illustrating a state where each of the plurality of multiplexed data processing devices transmits processed data to an output device, and the output device selects and outputs one of a plurality of processed data pieces;

FIG. 4 is a view illustrating a state where a portion of the data processing devices, among the plurality of multiplexed data processing devices, transmits the processed data to the output device;

FIGS. 5A to 5C are views illustrating hardware configurations of the input device, the data processing device, and the output device, respectively;

FIG. 6 is a view for explaining an outline of a process executed in the information processing system;

FIG. 7 is a ladder chart illustrating a process executed in the information processing system, and mainly illustrates a process in a push mode;

FIG. 8 is a ladder chart illustrating a process executed in the information processing system, and mainly illustrates a process in a pull mode;

FIG. 9 is a functional block diagram of a processor of the input device;

FIG. 10 is a functional block diagram of a processor of the data processing device;

FIG. 11 is a functional block diagram of a processor of the output device;

FIG. 12 is a flowchart of a process executed by the processor of the input device;

FIG. 13 is a flowchart of a process executed by the processor of the data processing device;

FIG. 14 is a flowchart of a process executed by the processor of the output device;

FIG. 15 is a ladder chart of a process executed in the information processing system in a case where, for example, a failure has occurred in the data processing device;

FIG. 16 is a flowchart of a process executed by the processor of the output device and relating to changing a transmission destination of a data request signal mainly at the time of a failure occurrence;

FIG. 17 is a view illustrating contents of processed data held in a data buffer unit in each of a first data processing device and a second data processing device;

FIG. 18 is a ladder chart of a process executed in the information processing system in a case where a packet loss is detected;

FIG. 19 is a flowchart of a process executed by the processor of the output device mainly in a case where a packet loss has occurred; and

FIG. 20 illustrates a configuration of the information processing system in which each data processing device includes a plurality of stages of data processors.

### DESCRIPTION OF EMBODIMENTS

In an information processing system having a plurality of multiplexed data processing servers, since each of the plurality of data processing servers transmits processed data to an output server, data traffic increases in a data communication of the plurality of data processing servers with the output server.

The information processing system disclosed in the present embodiment includes an input device, a plurality of data processing devices each of which is connected to the input device, and an output device connected to each of the plurality of data processing devices. The input device transmits processing data to each of the plurality of data processing devices, and each of the plurality of data processing devices executes a data processing on the processing data to generate processed data.

Each of the plurality of data processing devices may transmit processed data to the output device. The output device has a function of requesting a data processing device selected among the plurality of data processing devices, to transmit processed data. The data processing device that has received a transmission request of the processed data from the output device transmits the processed data to the output device in response to the corresponding request. In this manner, a process mode in which the processed data is transmitted in response to the request from the output device will be referred to as a pull mode in the present specification. In other words, in a pull mode, the data processing device does not transmit the processed data to the output device when a request signal of the processed data is not received. A process mode in which the data processing device autonomously and sequentially transmits processed data pieces to the output device without depending on a request from the output device, will be referred to as a push mode. In the push mode, since each of the plurality of data processing devices transmits processed data to the output device, data traffic increases. Meanwhile, in a pull mode, since a specific data processing device selected by the output device transmits processed data in response to a request from the output device, data traffic may be suppressed.

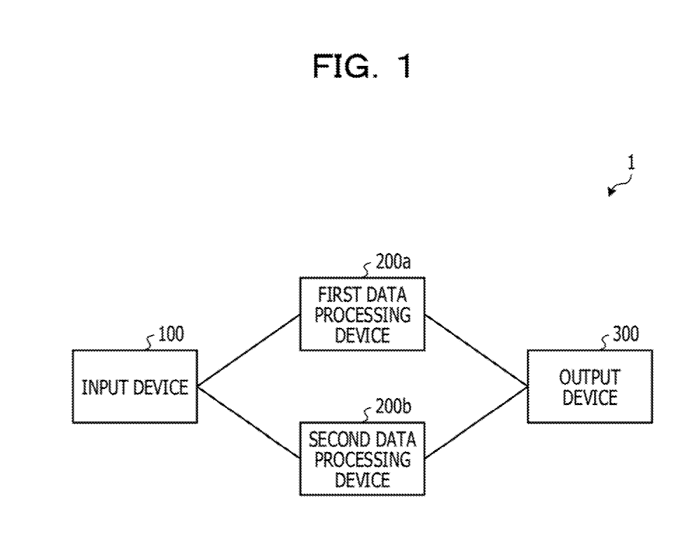

FIG. 1 is a configuration view of an information processing system 1 including a plurality of multiplexed data processing devices. The information processing system 1 includes an input device 100, a first data processing device 200a and a second data processing device 200b which are connected to the input device 100 and multiplexed (hereinafter, the first data processing device 200a and the second data processing device 200b may be referred to as “data processing devices 200” when they are not distinguished from each other), and an output device 300 connected to each of the plurality of data processing devices 200. The input device 100, the data processing device 200, and the output device 300 are, for example, an input server, a data processing server, and an output server, respectively. The input device 100 and the data processing device 200 are connected to each other by a data line, and the data processing device 200 and the output device 300 are connected to each other by a data line.

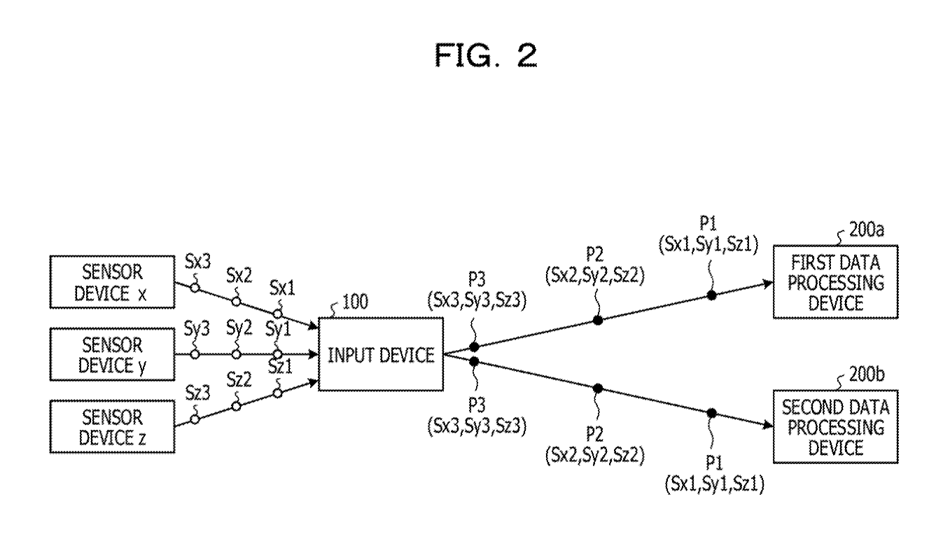

FIG. 2 is a view illustrating a state where the input device 100 receives sensor data from sensor devices, and transmits processing data to the data processing devices 200. Here, descriptions will be made on an example in which the sensor device is an earthquake sensor, and a process of detecting or predicting an occurrence of tsunami is performed based on sensor data of the earthquake sensor. As illustrated in FIG. 2, the input device 100 receives sensor data S from a plurality of sensor devices (sensor devices x, y, and z). Each of the plurality of sensor devices is an earthquake sensor disposed at each of different points, and transmits information on measured seismic intensity to the input device 100, for example, at an interval of 1 sec. In FIG. 2, the sensor device x sequentially transmits sensor data pieces Sx1, Sx2, and Sx3 acquired at different times to the input device 100. The sensor device y sequentially transmits sensor data pieces Sy1, Sy2, and Sy3 acquired at different times to the input device 100. The sensor device z sequentially transmits sensor data pieces Sz1, Sz2, and Sz3 acquired at different times to the input device 100.

The input device 100 sequentially receives the sensor data pieces S transmitted from each of the sensor devices and generates processing data P to be processed in the data processing device 200. For example, the input device 100 sequentially transmits processing data pieces P1, P2, and P3 to each of the plurality of data processing devices 200 at intervals of 1 sec. For example, the processing data P1 includes the sensor data pieces Sx1, Sy1, and Sz1, the processing data P2 includes the sensor data pieces Sx2, Sy2, and Sz2, and the processing data P3 includes the sensor data pieces Sx3, Sy3, and Sz3.

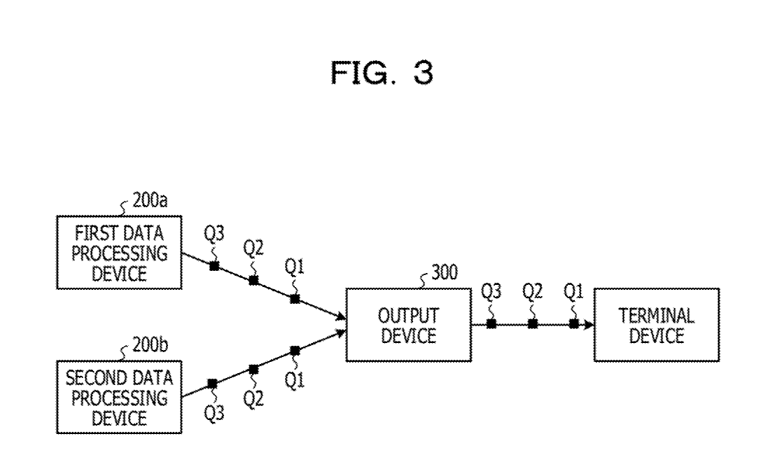

FIG. 3 is a view illustrating a state where each of the plurality of multiplexed data processing devices 200 transmits processed data to the output device 300, and the output device 300 selects and outputs one of a plurality of processed data pieces. In FIG. 3, each data processing device 200 transmits the processed data in the push mode.

Each of the plurality of data processing devices 200 sequentially executes predetermined data processings on the processing data pieces P1, P2, and P3 transmitted from the input device 100, thereby generating processed data pieces Q1, Q2, and Q3. Each of the processed data pieces Q1, Q2, and Q3 is, for example, an index indicating a probability of an occurrence of tsunami along with earthquake. Each of the plurality of data processing devices 200 sequentially transmits the processed data pieces Q1, Q2, and Q3 to the output device 300, for example, at intervals of 1 sec. In this manner, when the processed data Q is transmitted in the push mode, since the same processed data pieces Q are transmitted from the plurality of data processing devices 200, data traffic increases.

The output device 300 sequentially receives the processed data pieces Q1, Q2, and Q3 from each of the plurality of data processing devices 200, and transmits any one of the processed data pieces Q1, Q2, and Q3 to a terminal device capable of communicating with the output device 300. The terminal device is, for example, a portable terminal used by a user, and may notify the user of a tsunami forecast by using a screen or a sound device included in the terminal device.

In the example illustrated in FIG. 3, the output device 300 may not transmit all the processed data pieces Q1, Q2, and Q3 to the terminal device. In an example in which the processed data Q is an index indicating an occurrence probability of tsunami, only in a case where the index exceeds a predetermined value, the processed data Q may be transmitted to the terminal device. The output device 300 may output the processed data Q to a display device provided in the output device 300, or a display device connected to the output device 300.

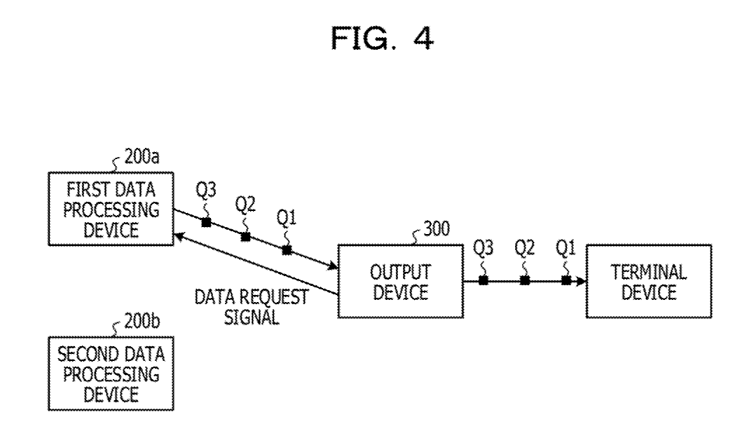

FIG. 4 is a view illustrating a state where a portion of the data processing devices 200, among the plurality of multiplexed data processing devices 200, transmits the processed data Q to the output device 300. In FIG. 4, each data processing device 200 transmits the processed data Q in the pull mode.

Each data processing device 200 receives the processing data P, executes a predetermined data processing on the processing data P, and generates the processed data Q. Here, the processed data Q is held in, for example, a data buffer provided in each data processing device 200, and each data processing device 200 does not spontaneously transmit the processed data Q to the output device 300.

Thereafter, the first data processing device 200a receives a data request signal from the output device 300. The first data processing device 200a transmits the processed data Q held in the data buffer to the output device 300 based on the reception of the data request signal. Meanwhile, the second data processing device 200b does not receive a data request signal, and thus, does not transmit the processed data Q to the output device 300. Accordingly, data traffic may be suppressed between the plurality of data processing devices 200 and the output device 300.

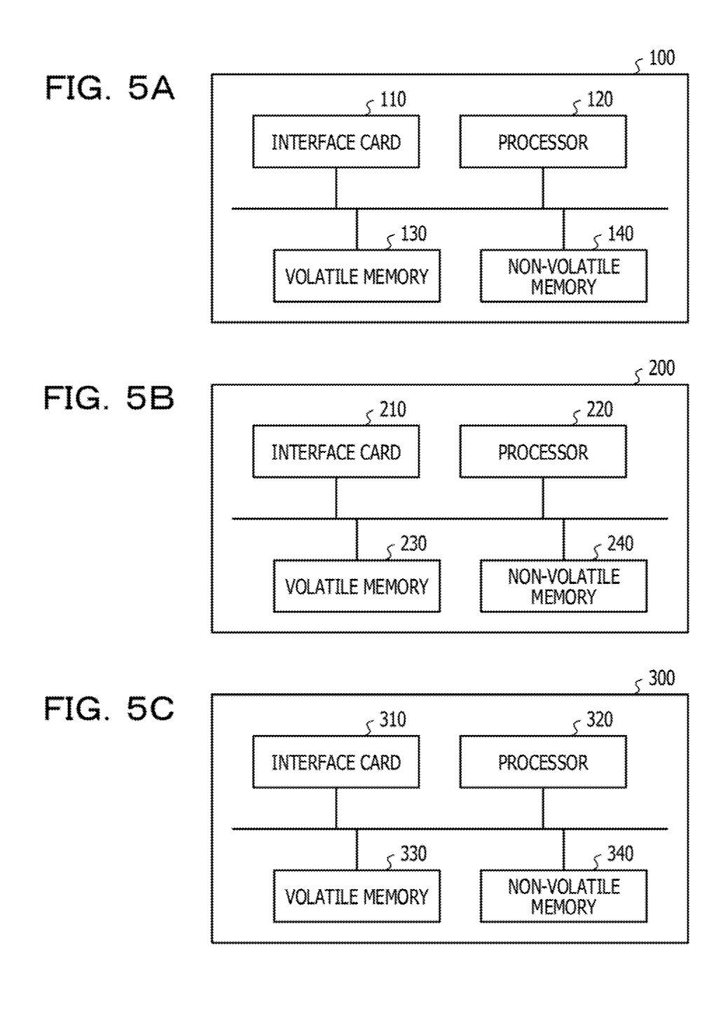

FIGS. 5A to 5C are views illustrating hardware configurations of the input device 100, the data processing device 200, and the output device 300, respectively.

FIG. 5A illustrates a hardware configuration of the input device 100, and the input device 100 includes an interface card 110, a processor 120, a non-volatile memory 130, and a volatile memory 140.

The interface card 110 receives sensor data S transmitted from the sensor device, and transmits processing data P to the data processing device 200.

The processor 120 loads a computer program stored in the non-volatile memory 130, on the volatile memory 140, and executes the computer program. For example, the processor 120 generates a data packet including the processing data P including the sensor data S. The processor 120 is a hardware processor, and for example, a central processing unit (CPU), a micro control unit (MCU), a micro processing unit (MPU), a digital signal processor (DSP), or a field programmable gate array (FPGA) may be applicable.

The non-volatile memory 130 is a computer-readable recording medium. In the non-volatile memory 130, for example, the computer program to be executed by the processor 120 is stored. The non-volatile memory 130 is, for example, a read only memory (ROM), a mask read only memory (mask ROM), a programmable read only memory (PROM), a flash memory, a magnetoresistive random access memory (MRAM), a resistance random access memory (ReRAM), or a ferroelectric random access memory (FeRAM). The computer program may be recorded in a computer-readable recording medium (excluding carrier waves) as a storage medium other than the non-volatile memory 130. A portable recording medium in which the computer program is recorded, such as a digital versatile disc (DVD) or a compact disc read only memory (CD-ROM), may also be distributed. The computer program may be transmitted via a network.

The volatile memory 140 is a computer-readable recording medium. On the volatile memory 140, the computer program stored in the non-volatile memory 130 is loaded. The volatile memory 140 is, for example, a static random access memory (SRAM) or a dynamic random access memory (DRAM).

FIG. 5B illustrates a hardware configuration of the data processing device 200, and the data processing device 200 includes an interface card 210, a processor 220, a non-volatile memory 230, and a volatile memory 240.

The interface card 210 receives the data packet including the processing data P transmitted from the input device 100, and transmits a data packet including processed data Q to the output device 300.

The processor 220 loads a computer program stored in the non-volatile memory 230, on the volatile memory 240 and executes the computer program. For example, the processor 220 executes a predetermined data processing on the processing data P, and generates the processed data Q. The processor 220 generates the data packet including the processed data Q. The processor 220 is a hardware processor, and for example, a CPU, an MCU, an MPU, a DSP, or an FPGA may be applicable.

The non-volatile memory 230 is a computer-readable recording medium. In the non-volatile memory 230, for example, the computer program to be executed by the processor 220 is stored. The non-volatile memory 230 is, for example, a ROM, a mask ROM, a PROM, a flash memory, an MRAM, a ReRAM, or a FeRAM. The computer program may be recorded in a computer-readable recording medium (excluding carrier waves) as a storage medium other than the non-volatile memory 230. A portable recording medium in which the computer program is recorded, such as a DVD, or a CD-ROM, may also be distributed. The computer program may be transmitted via a network.

The volatile memory 240 is a computer-readable recording medium. On the volatile memory 240, the computer program stored in the non-volatile memory 230 is loaded. The volatile memory 240 is, for example, an SRAM or a DRAM.

FIG. 5C illustrates a hardware configuration of the output device 300, and the output device 300 includes an interface card 310, a processor 320, a non-volatile memory 330, and a volatile memory 340.

The interface card 310 transmits a data request signal to the data processing device 200, receives the data packet including the processed data Q transmitted from the data processing device 200, and transmits the processed data Q to, for example, a terminal device.

The processor 320 loads a computer program stored in the non-volatile memory 330, on the volatile memory 340 and executes the computer program. For example, the processor 320 executes a processing of selectively transmitting the data request signal to a portion of the data processing devices 200 among the plurality of data processing devices 200. The processor 320 is a hardware processor, and for example, a CPU, an MCU, an MPU, a DSP, and an FPGA may be applicable.

The non-volatile memory 330 is a computer-readable recording medium. In the non-volatile memory 330, for example, the computer program to be executed by the processor 320 is stored. The non-volatile memory 330 is, for example, a ROM, a mask ROM, a PROM, a flash memory, an MRAM, a ReRAM, or an FeRAM. The computer program may be recorded in a computer-readable recording medium (excluding carrier waves) as a storage medium other than the non-volatile memory 330. A portable recording medium in which the computer program is recorded, such as a DVD or a CD-ROM, may also be distributed. The computer program may be transmitted via a network.

The volatile memory 340 is a computer-readable recording medium. On the volatile memory 340, the computer program stored in the non-volatile memory 330 is loaded. The volatile memory 340 is, for example, an SRAM or a DRAM.

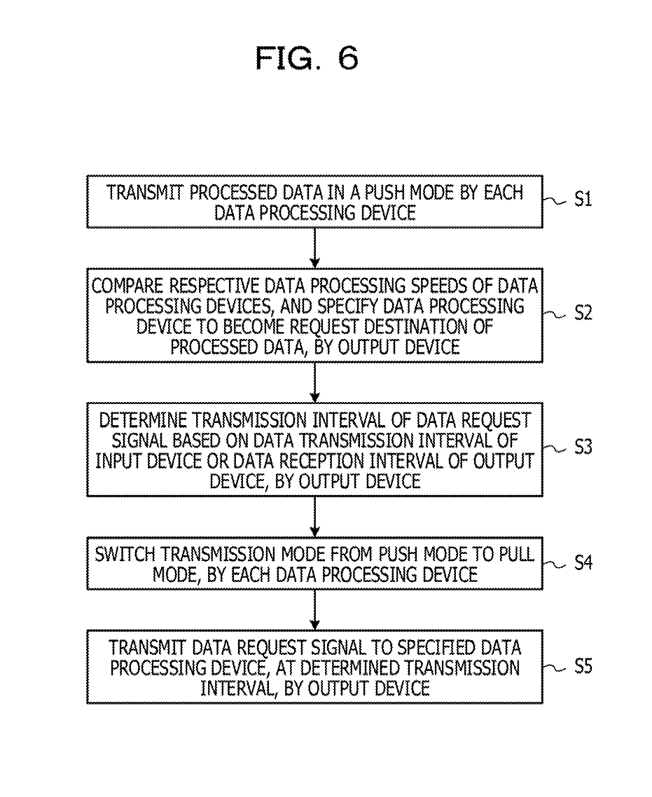

FIG. 6 is a view for explaining an outline of a process executed in the information processing system 1. In operation S1, each data processing device 200 transmits processed data Q in the push mode. Here, the same processed data pieces Q are transmitted to the output device 300 from the plurality of data processing devices 200. Next, in operation S2, the output device 300 compares respective data processing speeds of the data processing devices 200 to each other, and specifies a data processing device 200 to become a request destination of the processed data Q. For example, the output device 300 collects statistics indicating a data processing device 200 that has transmitted processed data Q that has reached the output device 300 for the fast time, for each processed data piece Q, and statistically specifies the data processing device 200 that has transmitted the processed data Q at the highest speed. In operation S3, the output device 300 specifies a transmission interval of a data request signal in the pull mode based on a transmission interval of processing data P by the input device 100 or a reception interval of the processed data Q by the output device 300. For example, the transmission interval of the data request signal is set to be the same as the transmission interval of the processing data Pin the input device 100 or the reception interval of the processed data Q in the output device 300. In the push mode, the data processing device 200 spontaneously sequentially transmits the processed data pieces Q to the output device 300 each time the processed data Q is generated. Meanwhile, in the pull mode, the data processing device 200 does not transmit the processed data Q until the data request signal is received. Accordingly, first of all, the information processing system 1 is operated in the push mode for a predetermined time period. Then, during the time period, the output device 300 learns, for example, the reception interval of the processed data Q. Thereafter, a transmission mode is switched to the pull mode, and the data request signals are sequentially transmitted from the output device 300 to the specified data processing device 200 at the transmission interval specified based on, for example, the learned reception interval of the processed data Q.

In operation S4, the transmission mode of each data processing device 200 is switched from the push mode to the pull mode. The switching of the transmission mode is performed when, for example, the output device 300 transmits a switching instruction signal of a mode to each data processing device 200. In operation S5, the output device 300 transmits the data request signals to the specified data processing device 200, at a determined transmission interval.

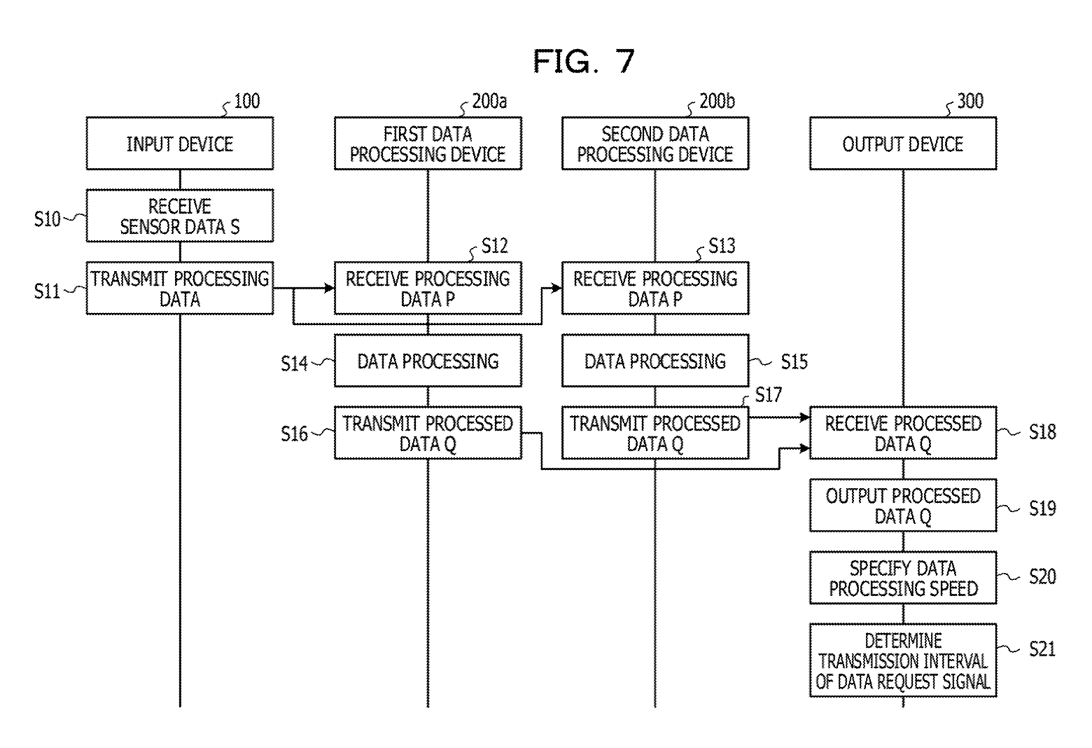

FIG. 7 is a ladder chart illustrating a process executed in the information processing system 1, and mainly illustrates a process in the push mode. In operation S10, the input device 100 receives sensor data S from a sensor device. In operation S11, the input device 100 transmits a data packet in which processing data P including the sensor data S is attached with time information and a packet identifier, to each of the plurality of data processing devices 200. The time information indicates a time at which the processing data P is generated, and the output device 300 may recognize a transmission interval of the processing data P based on the time information, and determine a transmission interval of a data request signal. The packet identifier is an identifier commonly used for the data packet including the processing data P and a data packet including processed data Q. In the drawings and subsequent portions of the present specification, the description “transmit processing data P” indicates “transmit a data packet including processing data P.”

In operations S12 and S13, each of the first data processing device 200a and the second data processing device 200b receives the data packet including the processing data P. In the drawings and subsequent portions of the present specification, the description “receive processing data P” indicates “receive a data packet including processing data P.” In operations S14 and S15, each of the first data processing device 200a and the second data processing device 200b executes a predetermined data processing on the processing data P, to generate processed data Q. In operations S16 and S17, each of the first data processing device 200a and the second data processing device 200b transmits a data packet including the processed data Q, to the output device 300. Here, each of the first data processing device 200a and the second data processing device 200b transmits the data packet to the output device 300 by the push mode. In the drawings and subsequent portions of the present specification, the description “transmit processed data Q” indicates “transmit a data packet including processed data Q.”

In operation S18, the output device 300 receives the data packet including the processed data Q from each of the first data processing device 200a and the second data processing device 200b. In the drawings and subsequent portions of the present specification, the description “receive processed data Q” indicates “receive a data packet including processed data Q.” In operation S19, the output device 300 transmits the processed data Q to, for to example, a terminal device. Since the output device 300 receives the same processed data pieces Q from the plurality of data processing devices 200, one processed data piece Q is selected from the same processed data pieces Q and is output.

In operation S20, the output device 300 compares respective data processing speeds of the plurality of data processing devices 200 to each other. For example, the output device 300 compares reception timings at the output device 300, for the plurality of processed data pieces Q having the same packet identifiers transmitted from the plurality of data processing devices 200. That is, the output device 300 specifies the data processing device 200 that has transmitted processed data Q that has reached the output device 300 for the first time. For example, it is assumed that the processed data Q transmitted from the first data processing device 200a has reached the output device 300 prior to the processed data Q transmitted from the second data processing device 200b. In this case, it is specified that the data processing speed of the first data processing device 200a is faster than the data processing speed of the second data processing device 200b. The comparison of the data processing speeds may be executed by obtaining an elapsed time since the processing data P is generated in the input device 100, based on the time information included in the data packet.

In operation S21, the output device 300 determines the transmission interval of the data request signal. For example, the output device 300 determines the transmission interval of the data request signal based on the transmission interval of the processing data P by the input device 100 or a reception interval of the processed data Q by the output device 300.

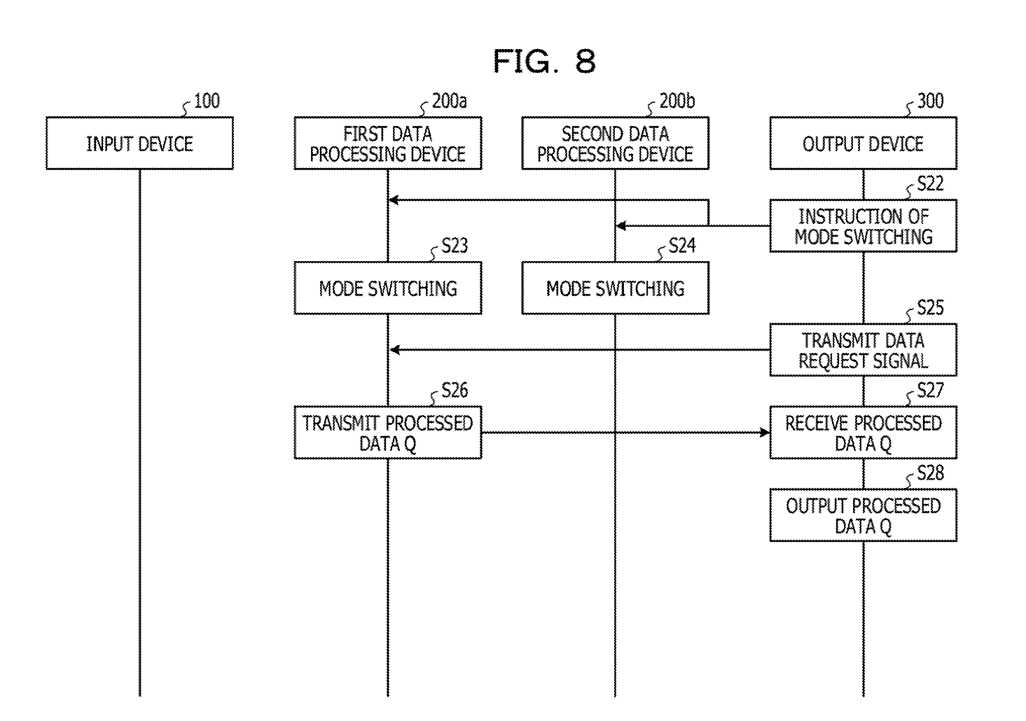

FIG. 8 is a ladder chart illustrating a process executed in the information processing system 1, and mainly illustrates a process in the pull mode. The processing illustrated in operation S22 is executed after operation S21 illustrated in FIG. 7. In operation S22, the output device 300 transmits an instruction signal for switching a transmission mode from the push mode to the pull mode, to each of the plurality of data processing devices 200. Based on the instruction signal for switching the transmission mode, in operations S23 and S24, each of the first data processing device 200a and the second data processing device 200b switches from the push mode to the pull mode. Accordingly, each of the first data processing device 200a and the second data processing device 200b does not transmit the processed data Q to the output device 300 until the data request signal is received.

Thereafter, in operation S25, the output device 300 transmits the data request signal. Here, the output device 300 selects any one of the data processing devices 200 based on the data processing speed specified in operation S20, and transmits the data request signal to the selected data processing device 200. For example, when the data processing speed of the first data processing device 200a is faster than the data processing speed of the second data processing device 200b, the output device 300 selectively transmits the data request signal to the first data processing device 200a.

In operation S26, the first data processing device 200a transmits the processed data Q in response to the data request signal. In operation S27, the output device 300 receives the processed data Q. Meanwhile, since the data request signal is not transmitted to the second data processing device 200b, the second data processing device 200b does not transmit the processed data Q to the output device 300. Therefore, as compared to the push mode illustrated in FIG. 7, data traffic may be suppressed between the second data processing device 200b and the output device 300. The output device 300 does not need to execute a processing of selecting and outputting one of the plurality of processed data pieces Q, and thus, it becomes possible to reduce the processing load of the output device 300. Further, it becomes possible to reduce the capacity of a data buffer provided in the output device 300.

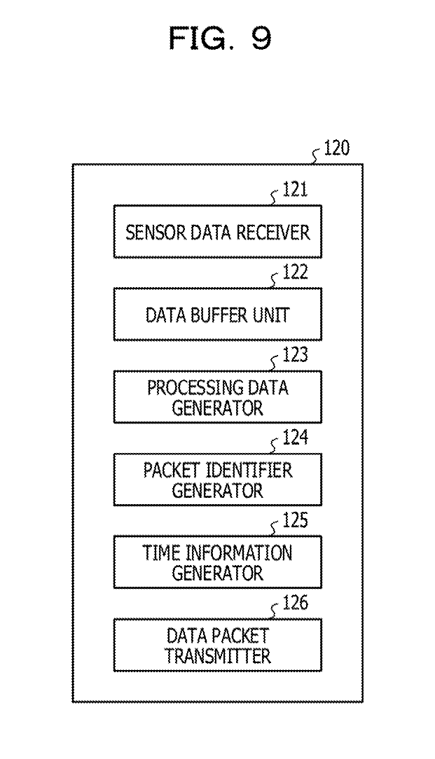

FIG. 9 is a functional block diagram of the processor 120 of the input device 100. The processor 120 functions as a sensor data receiver 121, a data buffer unit 122, a processing data generator 123, a packet identifier generator 124, a time information generator 125, and a data packet transmitter 126. The processor 120 may not perform all functions disclosed in FIG. 9 and may cause, for example, the function of the data buffer unit 122 to be executed by the volatile memory 140.

The sensor data receiver 121 receives sensor data S from a sensor device. The data buffer unit 122 holds the sensor data S. The processing data generator 123 generates processing data P including the sensor data S. For example, the processing data P1 including a plurality of sensor data pieces Sx1, Sy1, and Sz1 that are received by the sensor data receiver 121 at the same time or times close to each other, and are held by the data buffer unit 122 is generated.

The packet identifier generator 124 generates a packet identifier that identifies a data packet including the processing data P to be transmitted from the data packet transmitter 126. The time information generator 125 generates time information indicating a time at which the processing data P is generated. The data packet transmitter 126 transmits the data packet including the processing data P, the packet identifier, and the time information, to each of the plurality of data processing devices 200.

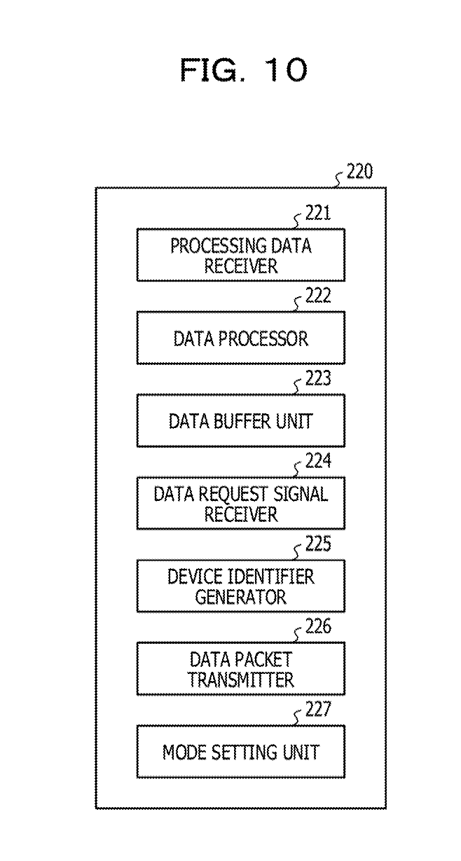

FIG. 10 is a functional block diagram of the processor 220 of the data processing device 200. The processor 220 functions as a processing data receiver 221, a data processor 222, a data buffer unit 223, a data request signal receiver 224, a device identifier generator 225, a data packet transmitter 226, and a mode setting unit 227. The processor 220 may not perform all functions disclosed in FIG. 10 and may cause, for example, the function of the data buffer unit 223 to be executed by the volatile memory 240.

The processing data receiver 221 receives the processing data P transmitted from the input device 100. The data processor 222 performs a predetermined data processing on the processing data P received by the processing data receiver 221, to generate processed data Q. The data buffer unit 223 holds the processed data Q generated by the data processor 222. The data buffer unit 223 may be a first in first out (FIFO)-type data buffer that discards the oldest data when there is no free space. The data request signal receiver 224 receives a data request signal transmitted from the output device 300. The device identifier generator 225 generates a device identifier for identifying a data processing device 200 that has performed the data processing. By this device identifier, the output device 300 that has received the processed data Q may identify a data processing device 200 that has transmitted the corresponding processed data Q among the plurality of data processing devices 200. The data packet transmitter 226 transmits a data packet including the processed data Q, the device identifier, the packet identifier, and the time information, to the output device 300. The mode setting unit 227 performs a control such that the data packet is to be transmitted in either the pull mode or the push mode as a transmission mode. In the push mode, regardless of whether the data request signal receiver 224 has received a data request, the processed data Q is transmitted to the output device 300. Meanwhile, in the pull mode, based on the reception of the data request signal by the data request signal receiver 224, the processed data Q is transmitted to the output device 300.

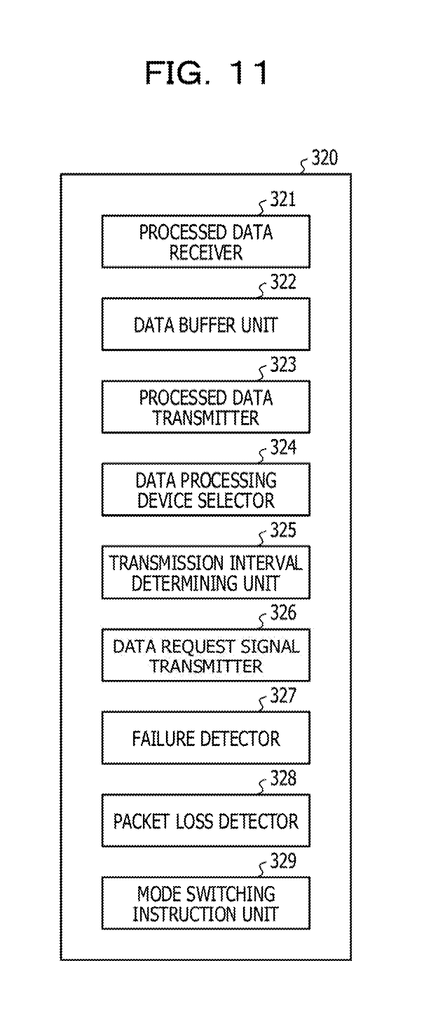

FIG. 11 is a functional block diagram of the processor 320 of the output device 300. The processor 320 functions as a processed data receiver 321, a data buffer unit 322, a processed data transmitter 323, a data processing device selector 324, a transmission interval determining unit 325, a data request signal transmitter 326, a failure detector 327, a packet loss detector 328, and a mode switching instruction unit 329. The processor 320 may not perform all functions disclosed in FIG. 11, and may cause, for example, the function of the data buffer unit 322 to be executed by the volatile memory 340.

The processed data receiver 321 receives the processed data Q transmitted from the data processing device 200. The data buffer unit 322 holds the processed data Q received by the processed data receiver 321. The processed data transmitter 323 transmits the processed data Q to, for example, a terminal device or outputs the processed data Q to a display device provided in the output device 300. The data processing device selector 324 selects a portion of the data processing devices 200 among the plurality of multiplexed data processing devices 200. The transmission interval determining unit 325 determines a transmission interval of the data request signal based on a transmission interval of the processing data P or a reception interval of the processed data Q. The data request signal transmitter 326 transmits the data request signal to the data processing device 200 selected by the data processing device selector 324, at the time interval determined by the transmission interval determining unit 325. The failure detector 327 detects an occurrence of a failure in the data processing device 200. For example, the failure detector 327 stores a time at which the data request signal is transmitted to a specific data processing device 200. Thereafter, when the processed data Q for the data request signal is not received by the processed data receiver 321 even after a predetermined time elapses, the failure detector 327 determines that there is a failure in the corresponding specific data processing device 200. The packet loss detector 328 detects a packet loss based on the packet identifier attached to the processed data Q. For example, when packet identifiers attached to a plurality of data packets that are sequentially received, respectively, are discontinuous, it is detected that a packet loss has occurred. The mode switching instruction unit 329 instructs the plurality of data processing devices 200 to switch between the push mode and the pull mode.

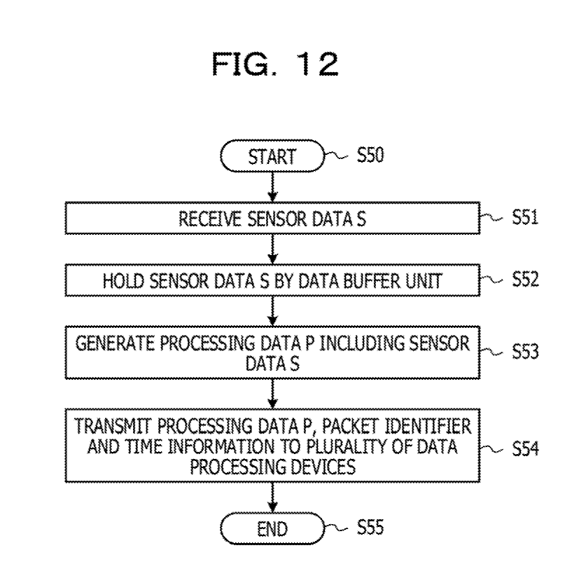

FIG. 12 is a flowchart of a process executed by the processor 120 of the input device 100. The processing flow is started by operation S50. In operation S51, the sensor data receiver 121 receives sensor data S. In operation S52, the data buffer unit 122 holds the sensor data S. In operation S53, the processing data generator 123 generates processing data P that includes the sensor data S received from a plurality of sensor devices, for example, during a predetermined time period. In operation S54, the data packet transmitter 126 transmits a data packet that includes the processing data P, a packet identifier generated by the packet identifier generator 124, and time information generated by the time information generator 125, to each of the plurality of data processing devices 200. The processing flow ends in operation S55.

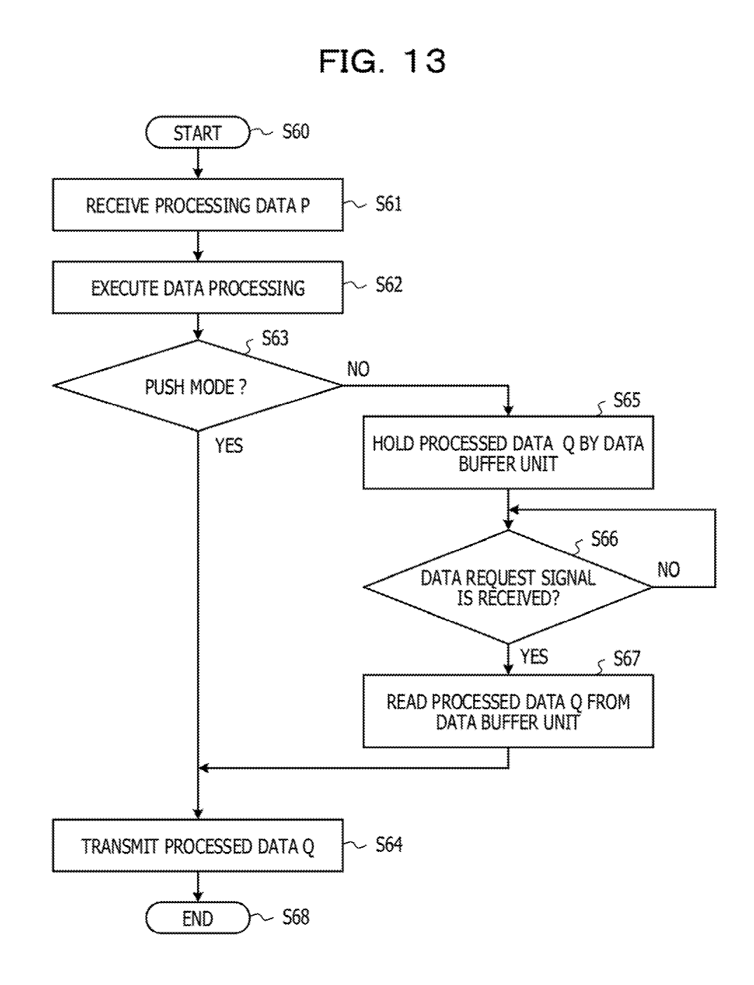

FIG. 13 is a flowchart of a process executed by the processor 220 of the data processing device 200. The processing flow is started by operation S60. In operation S61, the processing data receiver 221 receives the processing data P transmitted from the input device 100. In operation S62, the data processor 222 executes a predetermined data processing on the processing data P to generate processed data Q. In operation S63, the mode setting unit 227 determines whether a transmission mode is set to the push mode. When it is determined that the transmission mode is set as the push mode (“Yes”), the processing flow proceeds to operation S64. In operation S64, the data packet transmitter 226 transmits the processed data Q, which is attached with the packet identifier, the time information, and a device identifier generated by the device identifier generator 225, to the output device 300. The output device 300 determines from which data processing device 200 among the plurality of data processing devices 200 the processed data Q has been transmitted, based on the device identifier.

When it is determined that the transmission mode is not set to the push mode (“No”) in operation S63, that is, when the transmission mode is set to the pull mode, the processing flow proceeds to operation S65. In operation S65, the data buffer unit 223 holds the processed data Q. In operation S66, the data request signal receiver 224 determines whether a data request signal has been received. When it is determined that the data request signal has not been received (“No”), operation S66 is repeatedly executed in the processing flow. When it is determined that the data request signal has been received (“Yes”), the data packet transmitter 226 reads the processed data Q from the data buffer unit 223 in operation S67. Then, in operation S64, the data packet transmitter 226 transmits the processed data Q attached with the packet identifier, the time information, and the device identifier, to the output device 300. The processing flow ends in operation S68.

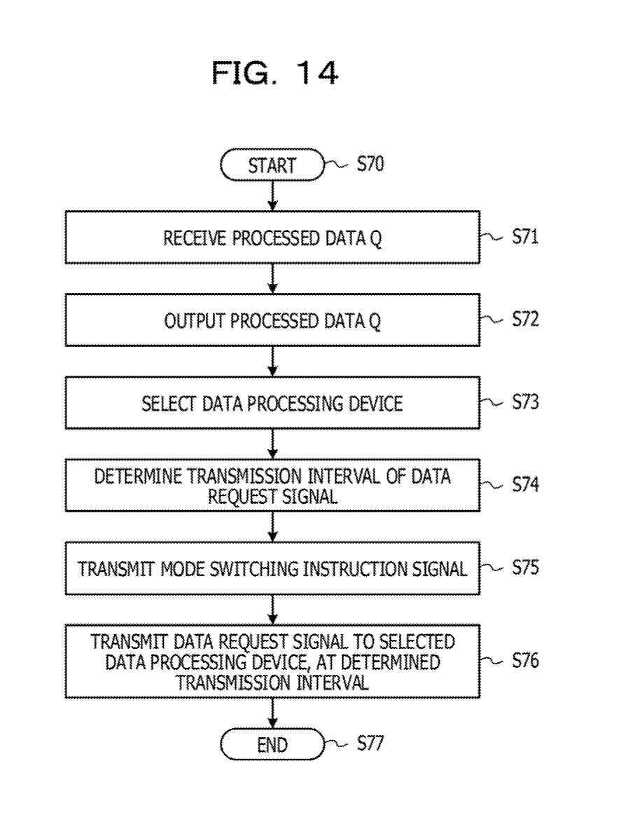

FIG. 14 is a flowchart of a process executed by the processor 320 of the output device 300. The processing flow is started by operation S70. In operation S71, the processed data receiver 321 receives the processed data Q. In operation S72, the processed data transmitter 323 transmits the processed data Q to, for example, a terminal device. The processed data Q may be held in the data buffer unit 322 before the processed data Q is output. In operation S73, the data processing device selector 324 selects a portion of the data processing devices 200 among the plurality of data processing devices 200, as a transmission destination of the data request signal. For example, among the plurality of data processing devices 200, a data processing device 200 having the highest data processing speed is selected as the transmission destination of the data request signal. The comparison between data processing speeds of the plurality of data processing devices 200 is performed by comparing times when the plurality of processed data pieces Q having different device identifiers and the same data identifier are received in the output device 300. In operation S74, the transmission interval determining unit 325 determines a transmission interval of the data request signal. For example, the transmission interval determining unit 325 specifies an average value of reception intervals of a plurality of data packets, and sets the transmission interval to the same value as the corresponding average value. In operation S75, the mode switching instruction unit 329 transmits a switching instruction signal for switching the transmission mode from the push mode to the pull mode, to each of the plurality of data processing devices 200. In operation S76, the data request signal transmitter 326 sequentially transmits the data request signals at the transmission interval determined in operation S74, to the data processing device 200 selected in operation S73. In the data processing device 200, the transmission mode is set to the pull mode based on the switching instruction signal transmitted in operation S75. Thus, the data processing device 200 that has received the data request signal transmits the processed data Q in response to the data request signal. Therefore, the output device 300 may sequentially receive and output the processed data pieces Q. The processing flow ends in operation S77.

As described above, in the present embodiment, the mode for the transmission from the plurality of multiplexed data processing devices 200 to the output device 300 is set to the pull mode, and a data request signal is selectively transmitted to a specific data processing device 200 among the plurality of data processing devices 200. Accordingly, data traffic may be suppressed.

Before the transmission mode is set to the pull mode, the same processed data pieces Q are transmitted from the plurality of data processing devices 200 to the output device in the push mode. Accordingly, the output device 300 may specify a data processing device 200 having a high data processing speed among the plurality of data processing devices 200, and select the data processing device 200 as a transmission destination of a data request signal. A transmission interval of the data request signal may be determined based on time information attached by the input device 100, or an interval of data packets received by the output device 300. Accordingly, the output device 300 may sequentially receive the plurality of processed data pieces Q at a proper interval.

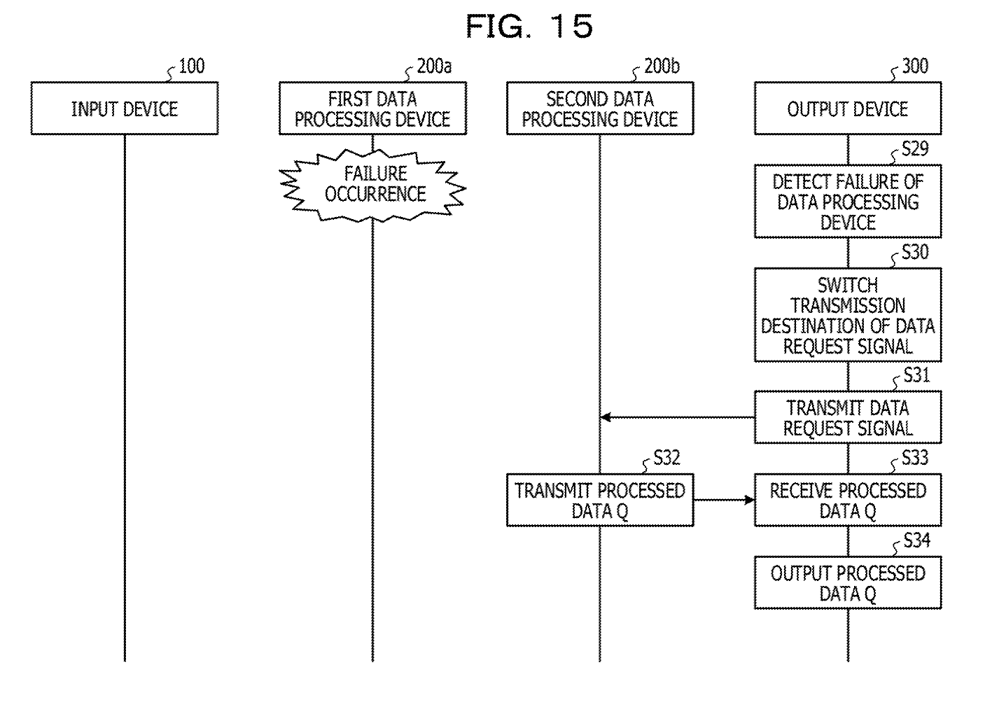

Next, descriptions will be made on a process in a case where, for example, a failure has occurred in the data processing device 200 that has selectively received a data request signal in the pull mode. FIG. 15 is a ladder chart of a process executed in the information processing system 1 in a case where, for example, a failure has occurred in the data processing device 200. Here, it is assumed that a failure has occurred in the first data processing device 200a in a state where the output device 300 selectively transmits a data request signal to the first data processing device 200a.

In operation S29, the output device 300 detects that a failure has occurred in the data processing device 200a. For example, the output device 300 determines that a failure has occurred in the first data processing device 200a when processed data Q is not transmitted from the first data processing device 200a even after a predetermined time elapses since the transmission of the data request signal. Then, in operation S30, the output device 300 switches a transmission destination of the data request signal, from the first data processing device 200a to another data processing device 200. For example, based on the data processing speed specified in operation S20 of FIG. 7, the output device 300 selects a data processing device 200 having the highest data processing speed, other than the first data processing device 200a, here, the second data processing device 200b, as a new transmission destination of the data request signal. Then, in operation S31, the output device 300 transmits the data request signal to the second data processing device 200b.

In operation S32, the second data processing device 200b transmits processed data Q to the output device 300 in response to the data request signal. In operation S33, the output device 300 receives the processed data Q, and in operation S34, the output device 300 outputs the processed data Q to, for example, a terminal device. In this manner, even in a case where a failure has occurred in any one of the data processing devices 200, the output device 300 may continuously output the processed data Q by properly switching the transmission destination of the data request signal.

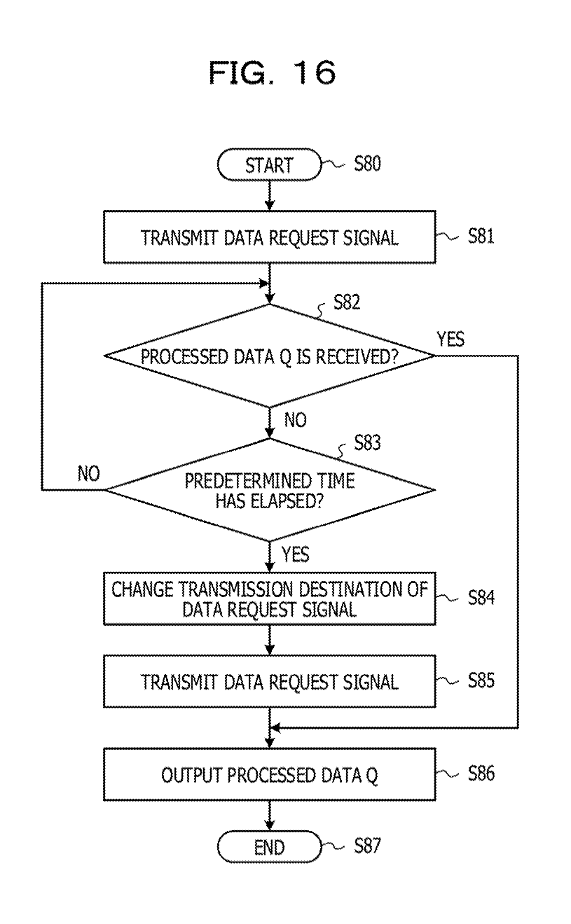

FIG. 16 is a flowchart of a process executed by the processor 320 of the output device 300 and relating to changing a transmission destination of a data request signal mainly at the time of a failure occurrence. The processing flow is started by operation S80. In operation S81, the data request signal transmitter 326 transmits a data request signal to a selected data processing device 200. In operation S82, the failure detector 327 determines whether processed data Q corresponding to the data request signal has been received. When it is determined that the processed data Q has been received (“Yes”), the processing flow proceeds to operation S86. When it is determined that the processed data Q has not been received in operation S82 (“No”), the processing flow proceeds to operation S83. In operation S83, the failure detector 327 determines whether a predetermined time has elapsed since the data request signal is transmitted. When it is determined that the predetermined time has elapsed since the data request signal is transmitted (“Yes”), the processing flow proceeds to operation S84. When it is determined that the predetermined time has not elapsed since the data request signal is transmitted (“No”), the processing flow returns to operation S82.

In operation S84, the data processing device selector 324 determines that the first data processing device 200a is failed, and changes a transmission destination of the data request signal to another data processing device 200, for example, the second data processing device 200b. When the information processing system 1 includes three or more data processing devices 200, a data processing device 200 having the highest data processing speed other than the first data processing device 200a may be selected. Next, in operation S85, the data request signal transmitter 326 transmits the data request signal to another data processing device 200. Thereafter, in operation S86, when the processed data receiver 321 receives processed data Q from another data processing device 200, the processed data transmitter 323 outputs the processed data Q. In this manner, when a failure has occurred in the data processing device 200 which is the transmission destination of the data request signal, the output device 300 may change the transmission destination of the data request signal to another data processing device 200, thereby continuously outputting the processed data Q.

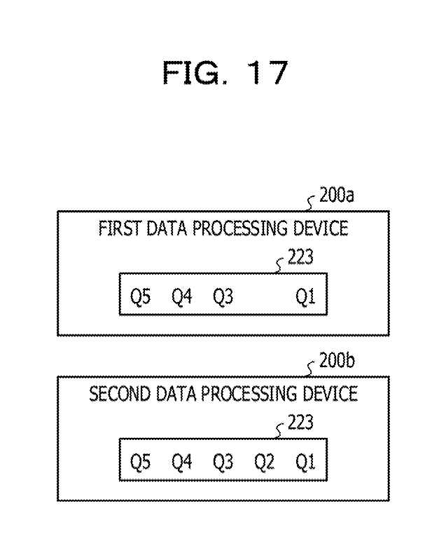

Next, descriptions will be made on a process in a case where a packet loss has occurred. FIG. 17 is a view illustrating contents of processed data Q held in the data buffer unit 223 in each of the first data processing device 200a and the second data processing device 200b. For example, in the data buffer unit 223 in the first data processing device 200a, processed data pieces Q1, Q3, Q4, and Q5 are sequentially held, but Q2 is deficient for some reason. The data deficiency may be caused due to, for example, a processing error in the input device 100, a communication error between the input device 100 and the data processing device 200, and a processing error in the data processing device 200. Meanwhile, in the data buffer unit 223 of the second data processing device 200b, processed data pieces Q1 to QS are sequentially held. In this state, it is assumed that the output device 300 has transmitted a data request signal to the first data processing device 200a. Upon receiving the data request signal after transmitting processed data Q1 to the output device 300, the first data processing device 200a transmits processed data Q3 to the output device 300. The output device 300 detects that processed data Q2 has not been received, based on a packet identifier attached to processed data Q. In this case, the output device 300 transmits a data request signal to the second data processing device 200b such that processed data Q2 is transmitted. In this case, the data request signal includes information that specifies the processed data Q2 as a request target, for example, a packet identifier corresponding to the processed data Q2. The output device 300 holds the processed data Q3 in the data buffer unit 322 until the processed data Q2 is received, and sequentially outputs the processed data Q2 and the processed data Q3 after the processed data Q2 is received.

In a modification of the method of detecting a packet loss, a data request signal may always include information that specifies processed data Q as a request target, for example, a packet identifier of the most recently transmitted processed data Q. In this case, when receiving a data request signal specifying processed data Q2, the first data processing device 200a notifies the output device 300 that the processed data Q2 is not held in the data buffer unit 223. Based on this notification, the output device 300 detects that a packet loss is occurring in the first data processing device 200a and requests another data processing device 200 to transmit the processed data Q2.

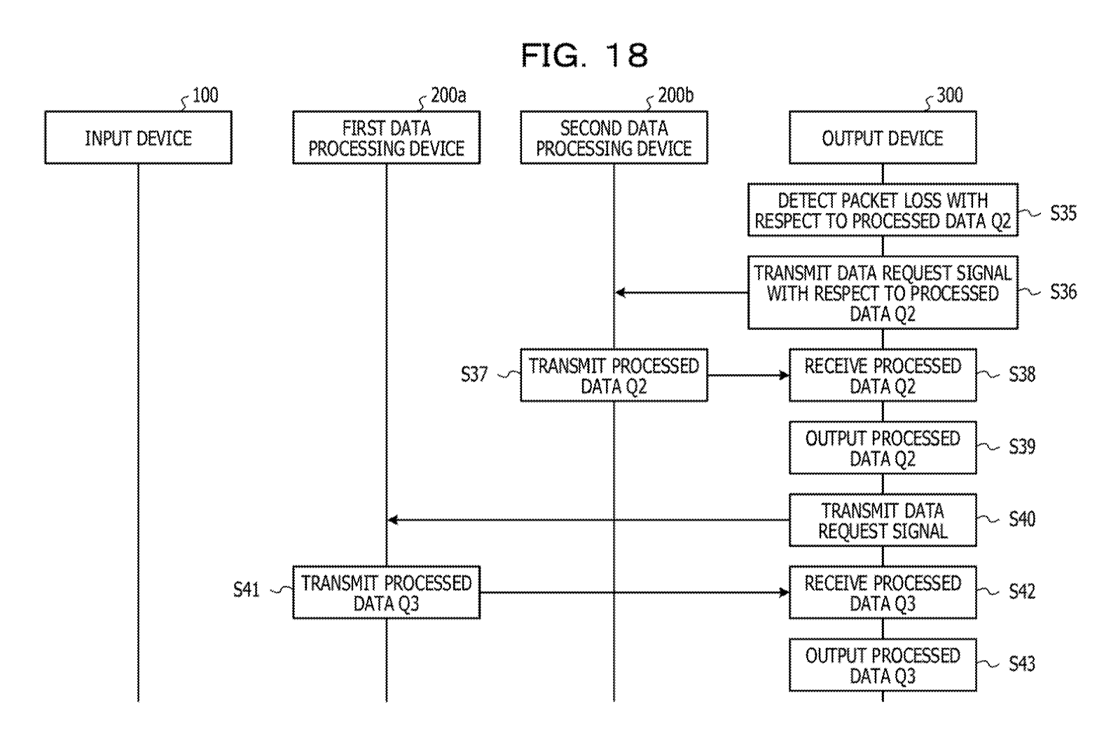

FIG. 18 is a ladder chart of a process executed in the information processing system 1 in a case where a packet loss is detected. Here, it is assumed that, in a state where the output device 300 selectively transmits a data request signal to the first data processing device 200a, a packet loss with respect to processed data Q2 has occurred in the first data processing device 200a as illustrated in FIG. 17.

In operation S35, the output device 300 detects a packet loss with respect to processed data Q2. In operation S36, the output device 300 transmits a data request signal including information that specifies the non-received processed data Q2, for example, a packet identifier, to the second data processing device 200b. In operation S37, the second data processing device 200b transmits processed data Q2 in response to the data request signal, to the output device 300. In operation S38, the output device 300 receives the processed data Q2. In operation S39, the output device 300 outputs the processed data Q2 to, for example, a terminal device. Thereafter, in operation S40, the output device 300 transmits a following data request signal to the first data processing device 200a. That is, after the output device 300 receives the processed data Q2 from the second data processing device 200b, a transmission destination of a data request signal is returned to the first data processing device 200a. Then, in operation S41, the first data processing device 200a transmits processed data Q3 to the output device 300 in response to the data request signal. In operation S42, the output device 300 receives the processed data Q3, and in operation S43, the output device 300 outputs the processed data Q3.

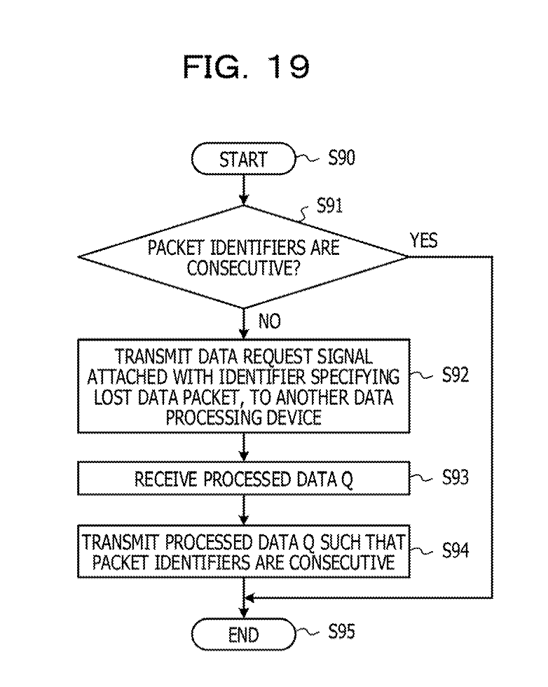

FIG. 19 is a flowchart of a process executed by the processor 320 of the output device 300 mainly in a case where a packet loss has occurred. The processing flow is started by operation S90. In operation S91, the packet loss detector 328 determines whether packet identifiers attached to a plurality of received data packets, respectively, are consecutive. When it is determined that the packet identifiers are consecutive (“Yes”), the processing flow proceeds to operation S95 and ends. When it is determined that the packet identifiers are not consecutive (“No”), the processing flow proceeds to operation S92. When the packet identifiers are not consecutive, it is thought that a packet loss is occurring. Therefore, in operation S92, the data request signal transmitter 326 transmits a data request signal to another data processing device 200. Here, the transmitted data request signal includes information that specifies a lost data packet, for example, a packet identifier. Another data processing device 200, that has received the data request signal, transmits processed data Q held in its own data buffer unit 223, that is, processed data Q corresponding to the packet identifier included in the data request signal, to the output device 300.

In operation S93, the processed data receiver 321 receives the processed data Q transmitted from another data processing device 200. Then, in operation S94, the processed data transmitter 323 outputs the processed data Q such that the packet identifiers are consecutive. Thereafter, the processing flow ends in operation S95.

In this manner, when a packet loss is detected, the output device 300 transmits a data request signal to another data processing device 200 so as to compensate a lost data packet, and prevent the data deficiency.

As described above, descriptions have made on a process of continuously outputting processed data pieces Q in a case where, for example, a failure has occurred in a portion of the data processing devices 200 among the plurality of data processing devices 200, and in a case where a packet loss has occurred in the information processing system 1.

### Modification

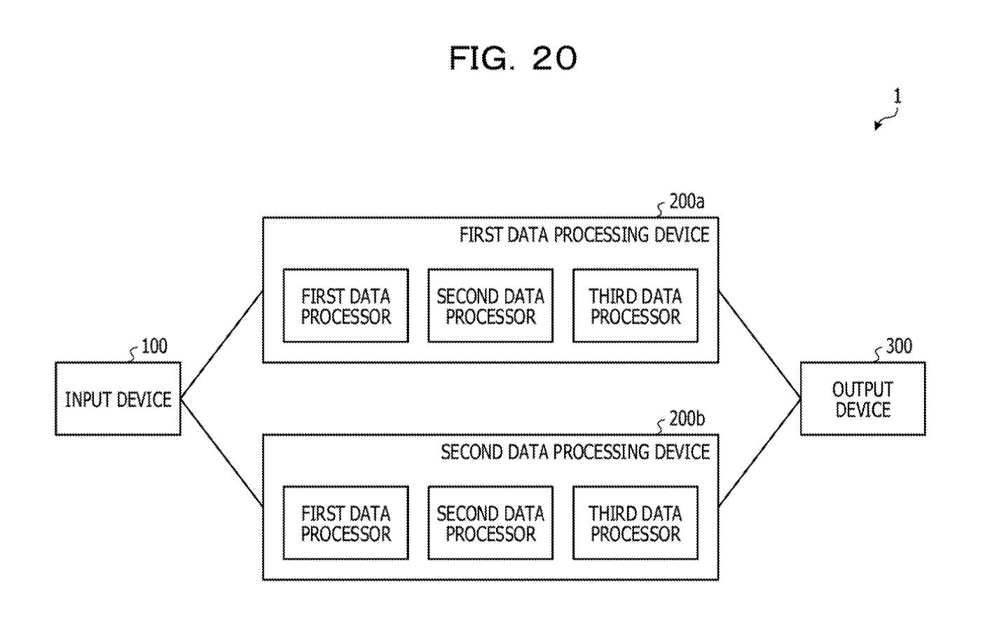

In the above embodiment, each of the plurality of data processing devices 200 may further include a plurality of stages of data processors. That is, a data processing executed by each data processing device 200 may include a plurality of partial data processings, and the plurality of stages of data processors may execute the plurality of partial data processings, respectively, in a pipe line manner. FIG. 20 illustrates a configuration of the information processing system 1 in which each data processing device 200 includes a plurality of stages of data processors. Each of the first data processing device 200a and the second data processing device 200b includes a first data processor, a second data processor, and a third data processor. The first data processor, the second data processor, and the third data processor execute a first partial data processing, a second partial data processing, and a third partial data processing, respectively, in a pipe line manner to generate processed data Q. Here, the transmission of data processed by the first data processor to the second data processor may be executed by the pull mode, and similarly, the transmission of data processed by the second data processor to the third data processor may be executed by the pull mode.

In another modification, for example, regarding a method of specifying data processing speeds of a plurality of data processing devices 200, the data processing speeds may be specified by the plurality of data processing devices 200, instead of the output device 300. In this case, each of the plurality of data processing devices 200 may notify the output device 300 of information indicating its own data processing speed. Alternatively, each of the plurality of data processing devices 200 may share information indicating its own data processing speed among the plurality of data processing devices 200, and may notify the output device 300 of information indicating the ranking of the data processing speed.

In another modification, regarding a method of determining a transmission interval of a data request signal, the input device 100 may notify the output device 300 of information indicating a transmission interval of processing data P, and the output device 300 may transmit a data request signal at the same interval as the transmission interval.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
an input device configured to include a first memory and a first processor coupled to the first memory, the first processor being configured to sequentially transmit a plurality of first processing data pieces to each of a plurality of data processing devices;
a data processing device of the plurality of data processing devices, coupled to the input device and configured to include a second memory and a second processor coupled to the second memory, the second processor being configured to sequentially execute data processings on a plurality of first processing data pieces to generate a plurality of first processed data pieces; and
an output device coupled to each of the plurality of data processing devices and configured to include a third memory and a third processor coupled to the third memory, the third processor being configured to sequentially transmit a plurality of first data request signals to a first data processing device selected among the plurality of data processing devices,
wherein the second processor of the first data processing device is configured to sequentially transmit the plurality of first processed data pieces to the output device in response to the plurality of first data request signals from the output device, respectively.

2. The information processing system according to claim 1,
wherein the second processor of a second data processing device of the plurality of data processing devices that does not receive the plurality of first data request signals, is configured to not transmit the plurality of first processed data pieces to the output device, and discard the plurality of first processed data pieces.

3. The information processing system according to claim 2,
wherein, after transmitting a first signal included in the plurality of first data request signals to the first data processing device, the third processor is configured to transmit a second data request signal to the second data processing device when first data included in the plurality of first processed data pieces is not transmitted by the second processor of the first data processing device, and
wherein the second processor of the second data processing device is configured to transmit the first data included in the plurality of first processed data pieces to the output device, based on the second data request signal.

4. The information processing system according to claim 2,
wherein, when a failure of the first data processing device is detected, the third processor is configured to change a transmission destination of the plurality of first data request signals from the first data processing device to the second data processing device.

5. The information processing system according to claim 2,
wherein the third processor is configured to:
compare a first data processing speed of the first data processing device to a second data processing speed of the second data processing device, and
transmit the plurality of first data request signals to the first data processing device when the first data processing speed is higher than the second data processing speed.

6. The information processing system according to claim 3,
wherein, when second data different from the first data is transmitted from the first data processing device in response to the first signal, the third processor is configured to:
acquire the first data from the second data processing device, and
sequentially output the first data and the second data.

7. The information processing system according to claim 1,
wherein, before receiving the plurality of first processing data pieces, the second processor is configured to:
sequentially receive a plurality of second processing data pieces from the input device,
generate a plurality of second processed data pieces by sequentially executing the data processings on the plurality of second processing data pieces, and
sequentially transmit the plurality of second processed data pieces to the output device, and
wherein the third processor is configured to:
sequentially receive the plurality of second processed data pieces from each of the plurality of data processing devices before sequentially receiving the plurality of first processed data pieces,
determine a transmission interval of a plurality of data request signals, based on one of a transmission interval of the plurality of second processing data pieces sequentially transmitted from the input device and a reception interval of the plurality of second processed data pieces sequentially received by the output device, and
sequentially transmit the plurality of data request signals at the determined transmission interval.

8. The information processing system according to claim 5,
wherein, before sequentially receiving the plurality of first processing data pieces, the second processor is configured to:
receive third processing data from the input device,
generate third processed data by executing the data processing on the third processing data, and
transmit the third processed data to the output device, and
wherein the third processor is configured to:
receive the third processed data from each of the plurality of data processing devices before sequentially receiving the plurality of first processed data pieces, and
compare the first data processing speed to the second data processing speed, based on a reception timing of the third processed data from each of the plurality of data processing devices.

9. A data processing method of an information processing system configured to include an input device, a plurality of data processing devices each of which is coupled to the input device, and an output device coupled to each of the plurality of data processing devices, the data processing method comprising:
sequentially transmitting a plurality of first processing data pieces to each of the plurality of data processing devices, by a first processor of the input device;
sequentially executing data processings on a plurality of first processing data pieces to generate a plurality of first processed data pieces, by a second processor of a data processing device of the plurality of data processing devices; and
sequentially transmitting a plurality of first data request signals to a first data processing device selected among the plurality of data processing devices, by a third processor of the output device,
wherein the second processor of the first data processing device is configured to sequentially transmit the plurality of first processed data pieces to the output device in response to the plurality of first data request signals from the output device, respectively.

10. The data processing method according to claim 9,
wherein the second processor of a second data processing device of the plurality of data processing devices that does not receive the plurality of first data request signals, does not transmit the plurality of first processed data pieces to the output device, and discards the plurality of first processed data pieces.

11. The data processing method according to claim 10,
wherein, after transmitting a first signal included in the plurality of first data request signals to the first data processing device, the third processor transmits a second data request signal to the second data processing device when first data included in the plurality of first processed data pieces is not transmitted by the second processor of the first data processing device, and
wherein the second processor of the second data processing device transmits the first data included in the plurality of first processed data pieces to the output device, based on the second data request signal.

12. The data processing method according to claim 10,
wherein, when a failure of the first data processing device is detected, the third processor changes a transmission destination of the plurality of first data request signals from the first data processing device to the second data processing device.

13. The data processing method according to claim 10,
wherein the third processor compares a first data processing speed of the first data processing device to a second data processing speed of the second data processing device, and transmits the plurality of first data request signals to the first data processing device when the first data processing speed is higher than the second data processing speed.

14. The data processing method according to claim 11,
wherein, when second data different from the first data is transmitted from the first data processing device in response to the first signal, the third processor acquires the first data from the second data processing device, and sequentially outputs the first data and the second data.

15. The data processing method according to claim 9,
wherein, before receiving the plurality of first processing data pieces, the second processor:
sequentially receives a plurality of second processing data pieces from the input device,
generates a plurality of second processed data pieces by sequentially executing the data processings on the plurality of second processing data pieces, and
sequentially transmits the plurality of second processed data pieces to the output device, and
wherein the third processor:
sequentially receives the plurality of second processed data pieces from each of the plurality of data processing devices before sequentially receiving the plurality of first processed data pieces,
determines a transmission interval of a plurality of data request signals, based on one of a transmission interval of the plurality of second processing data pieces sequentially transmitted from the input device and a reception interval of the plurality of second processed data pieces sequentially received by the output device, and
sequentially transmits the plurality of data request signals at the determined transmission interval.

16. The data processing method according to claim 13,
wherein, before sequentially receiving the plurality of first processing data pieces, the second processor:
receives third processing data from the input device,
generates third processed data by executing the data processing on the third processing data, and
transmits the third processed data to the output device, and
wherein the third processor:
receives the third processed data from each of the plurality of data processing devices before sequentially receiving the plurality of first processed data pieces, and
compares the first data processing speed to the second data processing speed, based on a reception timing of the third processed data from each of the plurality of data processing devices.
